(19) United States
(12) Patent Application Publication
(10) Pub. No.: US 2022/0226915 A1
(43) Pub. Date: Jul. 21, 2022

(54) A FOLDING HACKSAW

(71) Applicant: ESCADA INNOVATION LIMITED, The Gardens, Auckland (NZ)

(72) Inventors: Florian KERN, Eden Terrace, Auckland (NZ); Moveen LAL, The Gardens, Auckland (NZ)

(21) Appl. No.: 17/442,745

(22) PCT Filed: Mar. 24, 2020
(86) PCT No.: PCT/IB2020/052725

§ 371 Date: Sep. 24, 2021

(30) Foreign Application Priority Data
Mar. 26, 2019 (NZ) 752018

(51) Int. Cl. B23D 49/12; B23D 51/03; B23D 51/12; B25G 3/38

(52) U.S. Cl. CPC B23D 49/12; B25G 3/38; B23D 51/125; B23D 51/03

(57) ABSTRACT

A collapsible or folding saw is provided as a compact hand tool that when folded covers and protects the blade. The folding saw is movable between an extended useable condition and a folded condition. The saw comprises a frame having a longitudinal telescoping upper member, and first and second collapsible side supports depending from the upper member. A blade is coupled between the first and second collapsible side supports, whereby a tensioning mechanism is provided to tension the blade. Further, a handle is provided having a first portion pivotably coupled to the frame and wherein the handle pivots between a first condition to form a free-end handle and a second handle condition where the handle engages the upper member and encapsulates the blade.

### FIELD OF THE INVENTION

The present invention relates to a folding hacksaw. More particularly, but not exclusively, it relates to a folding hacksaw with a tensioning and locking mechanism.

### BACKGROUND OF THE INVENTION

Hacksaws are useful tools which may be used to cut metal, plastic or other materials. Hacksaws may be used in construction, in a household, military, search and rescue or camping for example.

Hacksaws generally have a frame and a blade supported by the frame. The generally rectangular profile formed by the frame and blade is usually necessary to support the thin blade, and provide controlled and effective cutting.

However, due to this profile, traditional hacksaws are often difficult to transport and/or store. The size and profile of many hacksaws do not fit well into a toolbox or other storage options. Consequently, hacksaws may need to be transported separately from other tools, or when it is in a storage box it can take up too much space.

Furthermore, the sharp blade of a hacksaw when exposed will be a safety issue, and may also cause damage to clothing or other tools or tool bits. Blade covers are sometimes used to cover saws. However, the blade of a hacksaw is generally thin, and therefore it may be difficult to slide a blade cover over the blade of a hacksaw. Additionally, sliding traditional blade covers over a blade may lead to injury, and blade covers are prone to being lost.

It may therefore be desirable to provide a hacksaw which is easy to transport and store easily and safely, while providing a hacksaw which is able to cut effectively.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purpose of this specification, where method steps are described in sequence, the sequence does not necessarily mean that the steps are to be chronologically ordered in that sequence, unless there is no other logical manner of interpreting the sequence.

It is an object of the present invention to provide a folding hacksaw which overcomes or at least partially ameliorates some of the abovementioned disadvantages or which at least provides the public with a useful choice.

### BRIEF DESCRIPTION OF THE INVENTION

According to a first aspect the invention broadly comprises a folding hacksaw movable between an extended useable condition and a folded condition comprising:
a frame having:
   a longitudinal upper member,
   a first collapsible side support depending from a front end of said frame and coupled at a first frame attachment point, and
   a second collapsible side support depending from a back end of said frame and coupled at a second frame attachment point,
a blade having a first blade end coupled to the first collapsible side support and a second blade end coupled to the second collapsible side support,
a tensioning mechanism to tension the blade,
a handle having a first handle portion pivotably coupled to the frame at or near a back end of the frame, and
wherein the handle pivots between a first handle condition to form a free-end handle and a second handle condition where the handle engages the upper member and encapsulates the blade.

According to another aspect the tensioning mechanism moves the first frame attachment point and second frame attachment point away from each other to tension and lock the blade.

According to another aspect the longitudinal upper member comprises a first upper member and a second upper member, one or both of said upper members slidable relative to the other upper member in a single degree of freedom in a longitudinal direction, the first and second upper members are constrained from rotating.

According to another aspect the first collapsible side support is coupled to the first upper member and the second collapsible side support is coupled to the second upper member such that as the upper members slide to the extended useable position, the first frame attachment point and second frame attachment point moves away from each other to tension and lock the blade.

According to another aspect the tensioning mechanism is an over-centre tensioning mechanism located on the upper member to move the frame between an unlocked position and an over-centre locked position wherein the over-centre tensioning mechanism moves the first frame attachment point and second frame attachment point away from each other to tension and lock the blade.

According to another aspect the invention broadly comprises a folding hacksaw movable between an extended useable condition and a folded condition comprising:
a frame having:
   a longitudinal upper member comprising a first upper member and a second upper member, one or both of said upper members slidable relative to the other upper member in a single degree of freedom in a longitudinal direction, the first and second upper members are constrained from rotating,
   a first collapsible side support depending from a front end of said frame and coupled to the first upper member at a first frame attachment point, and
   a second collapsible side support depending from a back end of said frame and coupled to the second upper member at a second frame attachment point,
a blade having a first blade end coupled to the first collapsible side support and a second blade end coupled to the second collapsible side support, and
a handle coupled to the frame, and
an over-centre tensioning mechanism located on the upper member to move the frame between an unlocked position and an over-centre locked position, and
wherein the over-centre tensioning mechanism moves the first frame attachment point and second frame attachment point away from each other to tension and lock the blade.

According to another aspect the handle comprises a first handle portion pivotably coupled to the frame at or near a back end of the frame.

According to another aspect the handle pivots between a first handle condition to form a free-end handle and a second handle condition where the handle engages the upper member and encapsulates the blade

According to another aspect the handle comprises an inner handle channel adapted to encapsulate the blade in the hacksaw folded condition.

According to another aspect a proximal end of the first handle portion is pivotably coupled to the frame and a distal end of the first handle portion is pivotably coupled to a second handle portion.

According to another aspect a distal end of the second handle portion pivots towards the proximal end of the first handle portion to the first handle condition to form a free-end handle.

According to another aspect the first handle portion and second handle portions pivot together to conceal the inner channel of the handle in the first handle condition to form a comfortable grip.

According to another aspect the inner channel encapsulates the upper member when the hacksaw is in its folded condition to provide a compact hacksaw.

According to another aspect the handle further comprises a handle locking mechanism to lock the handle in the first handle condition.

According to another aspect the handle locking mechanism is located on the upper member.

According to another aspect the handle locking mechanism is one or a combination of the following features:
a) a locking thumbwheel,
b) a magnetic catch,
c) a recess in the upper member to receive a distal end of the second handle portion.

According to another aspect the over-centre tensioning mechanism comprises an over-centre link assembly having:
a first link element and a second link element pivotably coupled together at a first pivot point,
the first link element is pivotably coupled to the first upper member at a second pivot point, and
the second link element is pivotably coupled to the second upper member at a third pivot point,
wherein the pivoting motion of the first and second link elements causes one or both the first and second upper members to slide relative to the other first and second upper member.

According to another aspect the first and second upper members each comprises a longitudinal receiving slot to receive a corresponding second or third pivot point, the longitudinal receiving slot providing a centre-line for the first and second link elements to pivot relative to.

According to another aspect the first pivot point is forced a first distance from the centre-line in a first direction to the unlocked position, and the first pivot point is forced to a second distance from the centre-line in a second opposite direction to the over-centre locked position, wherein the second distance is less than the first distance.

According to another aspect the hacksaw comprises a pivot stop to limit the movement of the first pivot and limit the distance travelled in the second direction.

According to another aspect the pivot stop is located on one of the first or second link elements.

According to another aspect the hacksaw comprises a locked distance between the second and third pivot points greater than an unlocked distance between the second and third pivot points so that the first and second upper members are forced part and the blade is under tension in the greater locked distance.

According to another aspect the invention further comprises a lever to force the first pivot point between the unlocked and over-centre locked positions.

According to another aspect the invention further comprises a lever link to couple the lever to the first pivot point.

According to another aspect the upper member comprises a longitudinal guide slot to constrain and guide an end of the lever and allow it to be lowered during non-use.

According to another aspect the upper member comprises an underside channel to receive the blade in the folded condition.

According to another aspect the blade retracts upwards towards the upper member from the extended useable condition to the folded condition.

According to another aspect each of the first and second collapsible side supports comprises:
an upper side support portion coupled to the upper member and
a lower side support portion coupled to the blade, and
wherein the upper side support portion and the lower side support portion are pivotable coupled to each other at a pivot point.

According to another aspect the first and second collapsible side supports are collapsible inwards at the pivot point.

According to another aspect the invention further comprises a pivot blocking feature so that the collapsible side supports are not collapsible outwards past the hacksaw extended useable condition.

According to another aspect the pivot blocking feature is a movably mounted anti-pivot block having:
a blocking condition wherein the block engages a corresponding side support to prevent it from pivoting and
a non-blocking condition where the block does not engage the side support.

According to another aspect the upper side support portion comprises an outwardly facing side support channel adapted to receive the lower side support portion and a portion of the blade in the hacksaw folded condition.

According to another aspect the hacksaw has a height between 20 mm and 50 mm in the folded condition.

According to another aspect the hacksaw has a height between 1.0 and 1.8 times a height of the upper member in the folded condition.

According to another aspect the hacksaw in the folded condition has a length between 1.0 and 1.6 times a length of the blade.

According to another aspect the hacksaw in the folded condition has a length between 1.0 and 1.3 times a length of the blade.

According to another aspect the frame and the blade defines a substantially rectangular frame profile in the extended useable condition and a rectangular bar profile in the folded condition.

According to another aspect the frame and handle are metal.

Other aspects of the invention may become apparent from the following description which is given by way of example only and with reference to the accompanying drawings.

As used herein the term “and/or” means “and” or “or”, or both. As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 shows a perspective view of a folding hacksaw in an extended usable condition.

FIG. 2 shows a perspective view of a folding hacksaw in a folded condition.

FIG. 3 shows a side view of a folding hacksaw with a handle having two handle portions.

FIG. 4 shows a side view of a folding hacksaw with a handle forming a free-end.

FIG. 5 shows a side view of a folding hacksaw with collapsible side supports.

FIG. 6 shows a side view of a folding hacksaw before tensioning.

FIG. 7A shows a side view of a folding hacksaw with a lifted lever.

FIG. 7B shows a perspective view of a folding hacksaw with a lifted lever.

FIG. 8 shows a side view of a folding hacksaw in an extended usable condition after blade tensioning.

FIG. 9 shows a perspective view of an underside of the hacksaw.

FIG. 10 shows a bottom view of the upper member receiving the blade and side supports.

FIG. 11 shows a perspective view of FIG. 3.

FIG. 12 shows a perspective view of FIG. 6.

FIG. 13A shows a cross-sectional view of FIG. 6.

FIG. 13B shows a cross-sectional view of FIG. 8.

FIG. 14A-C are schematics showing the motion of an over-centre linkage assembly.

### DETAILED DESCRIPTION OF PREFERRED EMBODIMENTS

According to various aspects of the various embodiments of the present invention as illustrated in FIGS. 1-14C, there is provided a folding hacksaw 1 which will now be described. It will be appreciated that these figures illustrate the general principles of construction, and that the invention is not limited to the precise mechanical configurations illustrated. For example, the illustrated embodiment relates to hacksaw, although it will be appreciated that other hand saws in which the frame provides tension to the blade will also included.

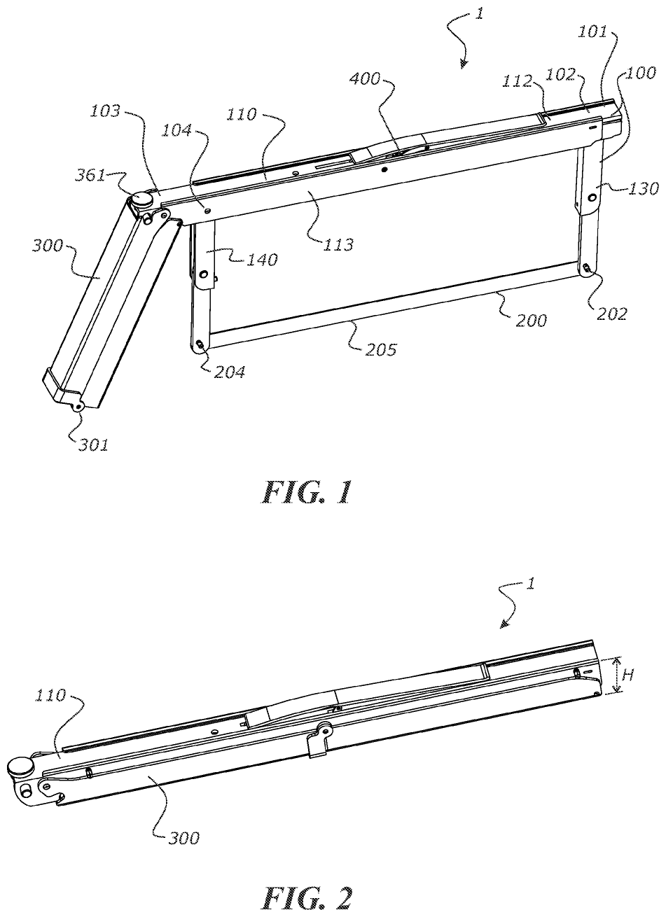

The folding hacksaw 1 is adapted to move between an extended useable condition as shown in FIG. 1 and a folded condition as shown in FIG. 2.

In the extended usable condition (FIG. 1), the folding hacksaw 1 is extended and locked rigidly into a position which allows the hacksaw to tension the blade to be used for cutting a workpiece. It is anticipated, that the described folding hacksaw 1 can be adapted to cut materials such as metal, plastics and wood for example.

In the folded condition (FIG. 2), the folding hacksaw 1 is collapsed to form a compact profile. In the folded condition, the folding hacksaw 1 may be carried safety and easily, and may be adapted to fit in a typical tool box, a holster or the pocket of a user for storage or transport.

As the folding hacksaw 1 can move between the extended and folded conditions, the folding hacksaw 1 may be transported and stored easily while the size and profile required for cutting performance will not need to be compensated.

The main structural components and couplings will now be briefly described.

As referenced in FIG. 1, in the preferred configurations, the folding hacksaw 1 comprises a frame 100, a blade 200 coupled to the frame, and a handle 300 coupled to the frame.

The frame 100 is adapted to locate and support the other components of the folding hacksaw directly or indirectly, such as the blade 200 which contacts and cuts the workpiece.

Preferably, the frame 100 comprises a longitudinal upper member 110.

Preferably, the frame 100 comprises collapsible side supports 130, 140. The collapsible side supports 130, 140 are expandable and collapsible between the extended useable condition and a folded condition of the hacksaw.

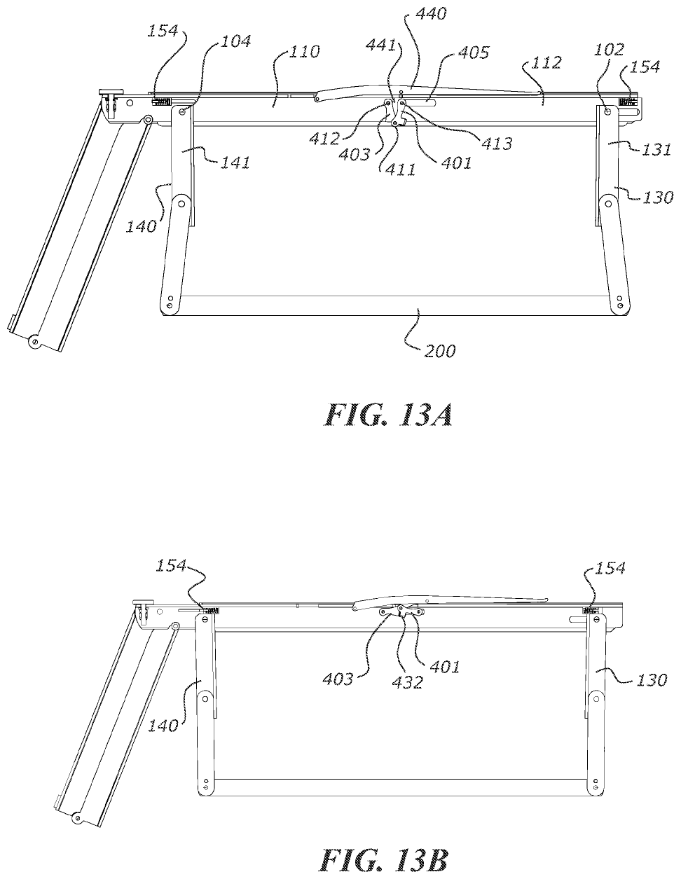

The first collapsible side support 130 depends from a front end 101 of the frame and is coupled at a first frame attachment point 102. The second collapsible side support 140 depends from a back end 103 of the frame and is coupled at a second frame attachment point 104. The frame attachment points 102, 104 are referenced in FIGS. 1 and 13A.

The front end 101 of the frame 100 may be defined as the end which is furthest from the user and is directed towards and/or contacts the workpiece first on a push stroke. The back end 103 of the frame 100 may be defined as the end opposite the front end 101, and is typically closest to the user.

Preferably, the blade 200 is coupled to the collapsible side supports 130, 140. A first blade end 202 of the blade 200 is coupled to the first collapsible side support 130 and a second blade end 204 is coupled to the second collapsible side support 140.

The handle 300 is adapted to provide an easy and comfortable location for a user to hold onto. Preferably, the handle 30 is separate (although coupled) to the frame 100 (described in more detail below). A user's push and pull motion of the handle 300 will provide the forward and back cutting motion of the blade 200.

Preferably, the folding hacksaw 1 further comprises a tensioning mechanism 400 to tension the blade 200.

In the preferred configurations, the tensioning mechanism 400 moves the first frame attachment point 102 and second frame attachment point 104 away from each other to tension and lock the blade.

It is important the blade 200 is held under tension so that the blade does not flex and bow during cutting which may be dangerous for the user (as the blade may slip off the workpiece) and/or may result in cuts which are not straight. A blade 200 which does not flex or bow during cutting should also provide a more efficient transfer of force from the user's arm motion to the blade's cutting motion.

### Folding Handle

In the most preferred configurations, the folding hacksaw 1 comprises a multipurpose handle 300 which functions both as a handle and also as a protective cover for the blade 200.

Preferably, the folding hacksaw 1 comprises a handle 300 which has a first handle condition as shown in FIG. 4, forming a free-end handle. Preferably, the folding hacksaw 1 also has a second handle condition as shown in FIG. 2 where the handle engages the upper member 110 and encapsulates the blade 200.

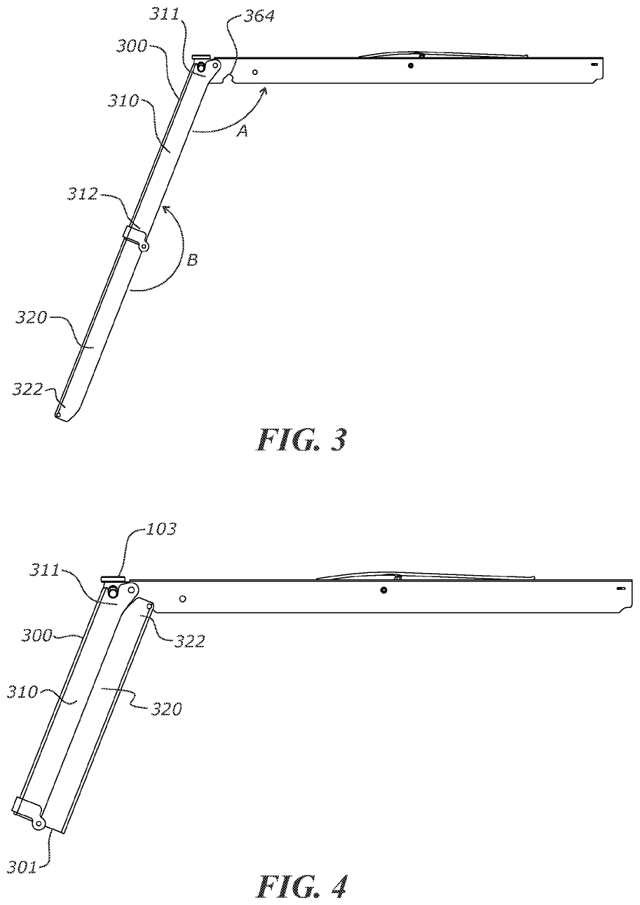

In the preferred configurations, the handle 300 opens up from a first handle position as shown in FIG. 4, to a second handle position in the form of a protective cover as shown in FIG. 3, and the handle then pivots to encapsulate the blade 200 in FIG. 2.

In the first handle condition (FIG. 4), the handle 300 provides a portion of the folding hacksaw 1 which can be grasped onto by the user's hand. The handle 300 in the first handle condition is sized and profiled to sit comfortably within the grip of the user. A user may grasp the handle 300 tightly without hurting their hand, so that they can provide sufficient force to cut the workpiece, especially if the workpiece is formed from a dense material.

In the first handle condition, a free-end handle 300 is formed. The handle 300 comprises a free-end 301 which is not directly coupled to the frame 100.

In the second handle condition (FIG. 2), the handle 300 functions as a protective cover. When functioning as a protective cover, the handle 300 covers at least the bottom edge of the blade, where the blade teeth 205 is located. The blade teeth 205 is sharp, as it is used to cut through material, so it can be unsafe when exposed.

In the preferred configurations, the handle 300 encapsulates the blade 200.

In some configurations, the handle 300 also encapsulates the upper member 110 to form a compact hacksaw when it is in the folded condition.

It is desirable to cover the blade teeth 205 when the folding hacksaw 100 is not in use. A covered blade 200 will increase the lifespan of the blade and improve safety. An exposed blade may be a safety hazard, as workers may unknowingly injure themselves, or damage clothing on the blade. When placed in a toolbox or other storage locations, an exposed blade may scratch or damage other tools or tool bits. Furthermore, an exposed blade may lead to faster wear and tear as it comes into contact people or articles, or is exposed to the elements if it is left outdoors. The folding hacksaw 100 may also slide in and out of a pocket easily when folded.

The described handle 300 which acts as a protective cover may also be advantageous as the protective cover is integrated with the folding hacksaw 100. The protective cover is integrated as it forms part of the folding hacksaw 100, and a separate protective component is not required. The handle 300 can include branding, colours, or have other markings as desired. A separate protective component is less desirable, as it would be less convenient to use, and may be easily lost.

Preferably, the handle 300 is located at or near a back end 103 of the frame as referenced in FIG. 4. Preferably, the handle 300 has a first handle portion 310 pivotably coupled to the frame 100 at or near a back end 103 of the frame.

Preferably, a proximal end 311 of the first handle portion 310 is pivotably coupled to the frame 100.

The pivotably coupled handle 300 allows the handle to pivot between the first and second handle conditions (to function as a handle or a protective cover respectively).

Arrow A in FIG. 3 illustrates the direction the first handle 310 would pivot to travel from a first to second handle condition in the preferred configurations.

In the preferred configurations, the handle 300 has a second handle portion 320 pivotably coupled to the first handle portion 310. Preferably, a distal end 312 of the first handle portion 310 is pivotably coupled to the second handle portion 320.

In the preferred configurations, a distal end 322 of the second handle portion 320 pivots towards the proximal end 311 of the first handle portion 310 to the first handle condition to form a free-end handle as shown by arrow B.

A separate handle 300 with a free-end 301 is advantageous, as the user will not need to hold onto the frame while cutting. The described handle 300 provides an ergonomic design which allows for efficient and comfortable use of the hacksaw 1. As the handle 300 is separate from the frame 100, the collapsible side supports 130, 140 and/or other parts of the frame can be designed to fulfil their main structural purposes rather than providing an adequate handle (e.g. the desire to improve ease of collapsing the side supports would not need to compete with the desire to provide an ergonomic handle).

It is anticipated that the user may choose to hold the front end 101 of the frame to steady the frame during cutting. However, the folding hacksaw 1 is adapted to be mainly held at the handle 300 to transfer the force exerted by the user to the movement of the hacksaw.

Arrow B in FIG. 3 illustrates the direction the second handle 320 would pivot to travel from the second handle condition (protective cover) to the first handle condition (handle form) in the preferred configurations. A handle 300 comprising two handle portions is beneficial as it allows the handle to be more adaptable by adjusting the portions to achieve different profiles and therefore functions (e.g. handle and protective cover functions).

In the preferred configurations, the two pivoting handle portions 310 and 320 work in synergy to provide a short handle in the first handle condition, and a long protective cover in the second handle condition to cover the blade.

In the preferred configurations, the handle 300 comprises an inner handle channel 350 as shown in FIG. 11. The inner handle channel 350 is adapted to encapsulate the blade 200 in the hacksaw folded condition.

In some configurations, the handle channel 350 is also adapted to encapsulate the upper member 110.

In some configurations, the handle channel 350 is adapted to encapsulate all the frame 100 members, and provide a protective cover for at least one side of the folding hacksaw 1 when it is not being used.

Preferably, the first handle portion 310 and second handle portion 320 pivot together to conceal the inner channel 350 of the handle 300 in the first handle condition to form a comfortable grip (FIGS. 4, 9).

Concealing the inner channel 350 is this way is advantageous as the full perimeter of the handle 300 is comfortable to grasp onto. This is important when cutting with the hacksaw 1, as cutting requires forceful cutting motion. A disadvantage of most hacksaws which are collapsible is that comfort and therefore effective use of the hacksaw is compromised for providing a collapsing function. In the present invention, comfort, effective use, and collapsibility are all considered and provided.

The handle channel 350 is advantageous as it allows the handle 300 to engage with the frame and form a protective cover (FIG. 2). The size and profile of the handle channel 350 allow the protective cover to easily encapsulate the blade 200. This protective cover is advantageous over traditional blade covers which typically only provide a groove for the blade to slot into. The traditional blade covers are more difficult to use as the blade 200 is very thin, and locating the blade into a groove in a traditional blade cover is not as easy as the protective cover formed from the handle 300 as described.

The protective cover/handle 300 as described is coupled to the hacksaw 1 itself. As the movement of the cover is predetermined (by the mechanical couplings), the blade 200 can be covered easily and it is not necessary to locate the blade 200 and handle 300 together.

In the preferred configurations, in the second handle condition (FIG. 2), the handle 300 covers a majority of the blade length.

In the most preferred configurations, the handle 300 and covers the entire blade length.

As described above, a blade 200 which is covers a length of the blade during non-use is advantageous as it improves safety, and protects the blade and other tools from damage.

In the preferred configurations, the length of the first handle portion 310 and the length of the second handle portion 320 are substantially the same in length, so when the first and second handle portions pivot together to a second handle condition (handle), they form an ergonomic handle 300, generally having a substantially regular length and thickness.

In the hacksaw folded condition, the handle is in the second handle condition and acts as a protective cover to help protect the hacksaw in its compact form for easy transport or storage (FIG. 2).

Preferably, the folding hacksaw 1 defines a rectangular bar profile in the folded condition.

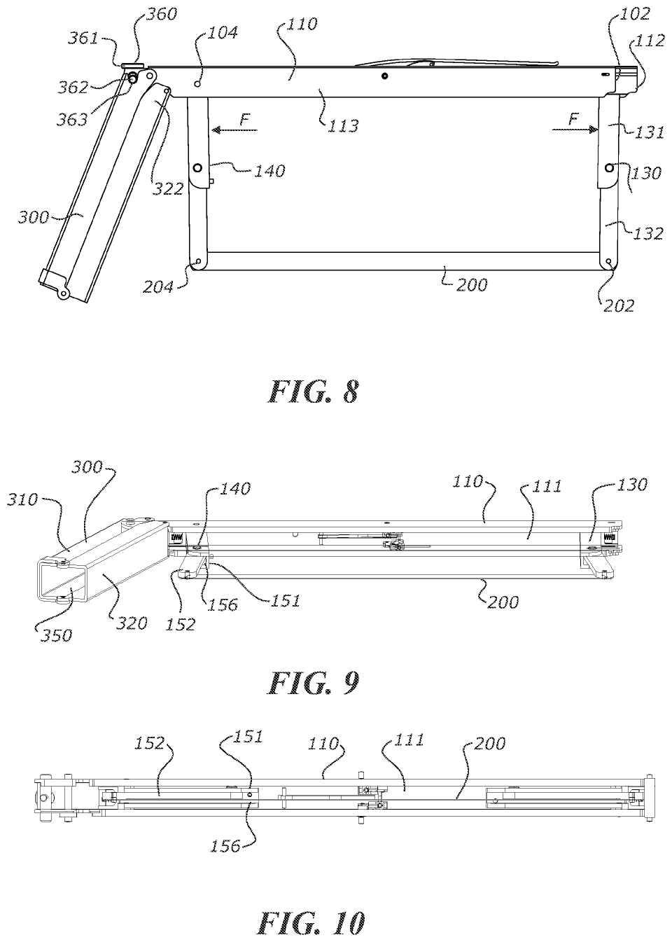

In the preferred configurations, the frame 100 and the blade 200 defines a substantially rectangular frame profile in the extended useable condition (FIG. 8).

In the preferred configurations, the folding hacksaw 1 comprises a handle locking mechanism 360 to rigidly lock the handle 300 and the first handle condition, as referenced in FIG. 8.

A handle locking mechanism 360 is a useful feature as it ensures that the handle 300 remains in its handle form. This may be especially important when the hacksaw 1 is in use during cutting, to provide a rigid and safe hacksaw which does not move to different configurations during use.

In some configurations, the handle locking mechanism 360 comprises a feature to force the handle 300 against the frame 100 to keep the handle in the first handle condition.

In some configurations, the hacksaw 1 comprises a locking thumbwheel 361 (referenced in FIGS. 1 and 8) which acts on a locking pin 362. Rotating the thumbwheel 361 will cause the locking pin 362 to translate. In this configuration, rotating the thumbwheel 361 causes the locking pin 362 to translate downwards against the handle 300 so that the handle pivots and locks against the frame 100. In some configurations, the handle comprises a handle recess 363 to receive the locking pin 362.

In some configurations, the frame 100 comprises a frame recess 364 to receive a portion of the handle 300 as referenced in FIG. 3.

In one configuration, the upper member 110 comprises a frame recess 364 to receive a second distal end 322 of the handle 300.

In some configurations, the handle 300 comprises a further locking mechanism comprises a magnetic catch, sprung ball catch, friction catch or any other suitable mechanisms known in the art to keep the handle in the second handle condition.

In other configurations, the handle locking mechanism comprises a mechanical latch to keep the handle in the first or second handle condition.

Optionally, the handle locking mechanism is a tensioning lever arm on locking pin 362.

The handle locking mechanism 360 may include other locking features known by a person skilled in the art.

In some configurations, the handle locking mechanism 360 is located on the upper member 110.

It is anticipated that the locking mechanism 360 may comprise one or a combination of the described features.

### Collapsible Sides

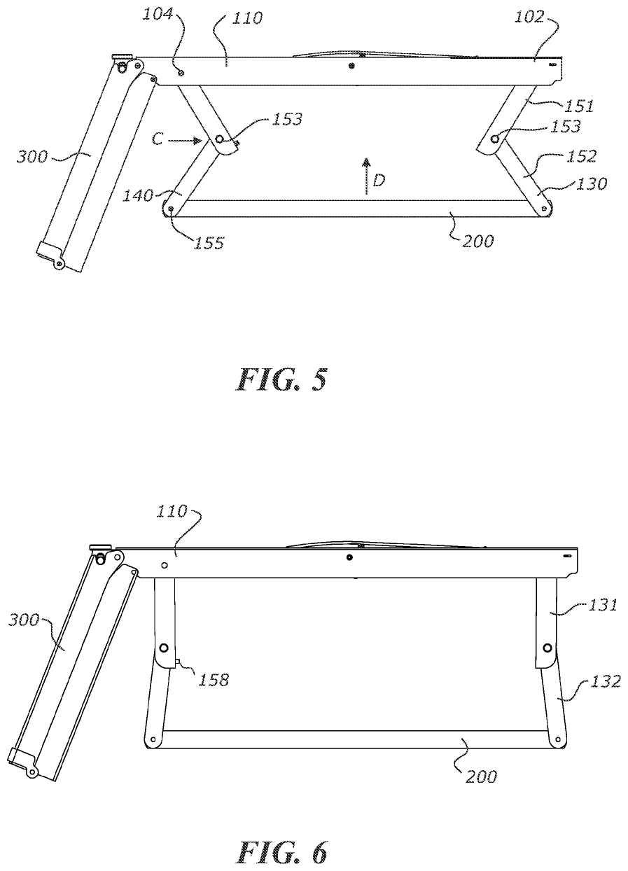

In one configuration, the collapsible side supports 130, 140 each have an upper side support portion 151 coupled to the upper member 110 and a lower side support portion 152 coupled to the blade 200 as referenced in FIGS. 5 to 8.

Preferably, the upper side support portion 151 and the lower side support portion 152 are linked and are pivotable coupled to each other at a pivot point 153.

In the extended usable condition as shown in FIG. 8, preferably the upper side support portion 151 and the lower side support portion 152 are substantially aligned along the longitudinal axis of the side support portions, so that the distance between the upper member 110 and the blade 200 is further than when the hacksaw is in the folded condition.

Preferably, in the extended usable condition, the upper and lower side support portions 151, 152 form a substantially straight side support 130.

Preferably, in the extended usable condition, an outward force (F) is exerted on the upper side support portions 131 as the first frame attachment point 102 and second frame attachment point 104 are forced away from each other.

Preferably, the folding hacksaw 1 comprises a pivot blocking feature 154 so that the collapsible side supports 130, 140 are not collapsible outwards past the hacksaw extended useable condition, and function to transmit a force into the blade to tension the blade.

Where the outward force (F) is exerted on the upper side support portions 131 and the pivot blocking feature 154 blocks the side supports 130, 140, the side supports form substantially straight supports as seen in FIG. 8.

In the preferred configurations, a pivot blocking feature 154 is associated with each side support 130, 140.

In other configurations, a pivot blocking feature 154 blocks one of the first and second side supports 130, 140 from pivoting outwards past the hacksaw extended useable condition. As the side supports 130, 140 are connected by the upper member 110, the other of the first and second side supports 130, 140 is also indirectly blocked from pivoting.

In the preferred configurations, the pivot blocking feature is a movably mounted anti-pivot block 154 moves from a non-blocking condition in the hacksaw folded condition, to a blocking condition in the hacksaw extended useable condition.

Preferably, the hacksaw comprises a gap between an underside of the upper member 110 and the top of the side supports 130, 140. The anti-pivot block 154 moves into the gap in the blocking condition, and out of the gap in the non-blocking condition.

In the blocking condition the block 154 engages a corresponding side support 130, 140 to prevent it from pivoting and in the non-blocking condition, the block does not engage the side support 130, 140.

When the hacksaw 1 is not in the extended useable condition (such as when the hacksaw is not under tension and/or the hacksaw is in the folded condition), the anti-pivot block 154 does not engage or jam the side support 130, 140 as shown in FIG. 13A (a cross-sectional view of FIG. 6), where the hacksaw is not under tension. In this condition, the upper side support portions 131, 141 are free to rotate about the frame attachment points 102, and 104 respectively.

The anti-pivot block 154 engages and blocks the side support 130, 140 in the hacksaw extended useable condition as shown in FIG. 13B (a cross-sectional view of the FIG. 8). When the anti-pivot block 154 engages with the side support 130, 140 they cannot pivot relative to the upper member 110.

In some configurations, the pivot blocking feature 154 comprises a spring 157 as referenced in FIG. 13A. The spring 157 links the pivot blocking feature 154 with the sliding upper member (the second upper member 113 slides in the illustrated configuration). The pivot blocking feature 154 stops over the side support 130, 140 to block it from pivoting, but the second upper member 113 keeps sliding to tension the blade. The spring 157 compresses as the second upper member 113 keeps sliding, while the pivot blocking feature 154 remains over the side support 130, 140.

Preferably, the spring 157 biases the tensioning and locking mechanism indirectly, so that when the hacksaw lock is released, the first and second upper members are biased towards each other to an initial non-tensioned condition.

In one configuration, the pivot blocking feature 154 is located on an underside of the upper member 110. In some configurations, the pivot blocking feature 154 is a protruding portion formed on the upper member 110. In other configurations, the pivot blocking feature 154 is a block which is attached to the upper member.

In the preferred configurations, the first and second collapsible side supports 130, 140 are collapsible inwards at the pivot point 153 as shown in FIG. 5. As the first and second collapsible side supports 130, 140 collapse inwards, the folding hacksaw 1 moves from the extended usable condition to the folded condition in FIG. 2.

Preferably, as the first and second collapsible side supports 130, 140 collapse inwards, the blade 200 is brought towards the upper member 110.

The feature ‘collapsible inwards’ may be defined as having at least a portion of the first and second collapsible side supports 130, 140 collapsing towards each other as shown by arrow C in FIG. 5.

Preferably, the blade 200 retracts upwards towards the upper member 110 from the extended useable condition to the folded condition as shown by arrow D.

In the preferred configuration, the pivot points 153 moved together, which draws the distal end 155 of the lower side support portion 152 upwards, which in turn draws the blade 200 up towards the upper member 110.

As shown in FIGS. 9 and 10, in the preferred configurations, the upper member 110 comprises an underside channel 111 to receive the blade 200 in the folded condition.

Preferably, the underside channel 111 of the upper member 110 also receives the collapsible side supports 130, 140.

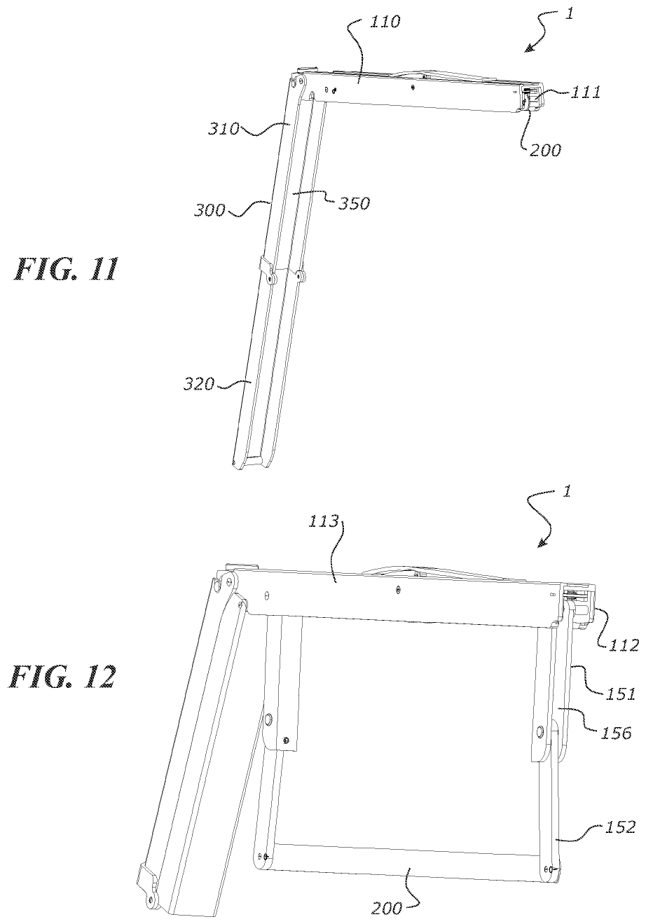

In some configurations, the upper side support portion 151 comprises a side support channel 156 (best seen in FIG. 12). The side support channel 156 is preferably outwardly facing and is adapted to receive the lower side support portion 152 and a portion of the blade 200 in the hacksaw folded condition as shown in FIG. 10.

The profile of the side support channel 156 preferably also functions as a pivot blocking feature, which limits or prevents outward pivoting of the collapsible side supports 130, 140. Preferably, the side supports 130, 140 are free to pivot inwards (FIG. 5) but not outwards as a sidewall of the side support channel 156 interferes with this movement.

In the preferred configurations the underside channel 111 of the upper member 110 and the side support channel 156 work in synergy to provide a compact folding hacksaw 1 when it is in its folded condition. The blade 200 and lower side support portion 152 fit into the upper side support portion 151. In turn, the upper side support portion 151 fits into the underside channel 111.

Preferably, in the folding condition, the upper member 110 receives all other frame 100 components in the underside channel 111.

In the preferred configurations, the handle 300 covers the underside channel 111 in the folded condition to provide a compact and protected hacksaw 1.

Preferably, in the folded condition, the hacksaw 1 is compact and is only marginally bigger than the upper member 110 itself, as most components can fit into the underside channel of the upper member.

In the preferred configurations, the hacksaw 1 has a height (H) between 20 mm and 50 mm in the folded condition (FIG. 2).

In the preferred configurations, the hacksaw 1 has a height (H) between 1.0 and 1.8 times the height of the upper member in the folded condition.

In the most preferred configurations, the hacksaw 1 has a height (H) between 1.0 and 1.3 times the height of the upper member in the folded condition.

### Upper Member

The upper member 110 of the folding hacksaw 1 is a structurally important component, as it is configured to support the other components of the folding hacksaw directly or indirectly, such as the collapsible side supports 130, 140, the blade 200 which contacts and cuts the workpiece, and the handle 300.

In the preferred configurations, the longitudinal upper member 110 comprises a first upper member 112 and a second upper member 113 (referenced in FIGS. 1, 8 and 12). The longitudinal upper member 110 is a multi-part longitudinal upper member having first and second upper members 112, 113.

Preferably, one or both of the upper members 112, 113 are slidable relative to the other upper member in a longitudinal direction.

In the configuration illustrated in FIG. 8, the first upper member 112 is slidable relative to the second upper member 113 in a single degree of freedom in a longitudinal direction.

Preferably, the first upper member 112 and second upper member 113 engage to constrain movement of the members to the single degree of translating freedom. Preferably the first and second upper members 112, 113 are constrained from rotating.

In some configurations, the first and second upper members 112, 113 partially nest together to constrain the relative movement of the members.

Preferably, the profile of the first and second upper members 112, 113 allows the members to interlock and to make it inseparable during sliding.

The upper member 110, having sliding first and second members, is configured to enable the tensioning mechanism of the preferred configurations of the folding hacksaw. As described previously, the tensioning mechanism is important as it keeps the blade 200 from flexing and bowing which would be a safety concern, or resulting in an inadequate cut.

The multi-part upper member 110 enables the tensioning mechanism by causing the first frame attachment point 102 and second frame attachment point 104 to move away from each other, as the first upper member 112 and the second upper member 113 are forced to slide away relative to each other (FIG. 8) in the direction of the arrows (F).

As the first upper member 112 and the second upper member 113 are forced to slide away from each other, the effective length of the upper member 110 increases.

For example, as the first upper member 112 slides past the second upper member 113, the effective length of the upper member 110 increases (FIG. 8), in comparison to the effective length of the member in its pre-sliding position (FIG. 6).

In the preferred configurations, the first collapsible side support 130 is coupled to the first upper member 112 at the first frame attachment point 102, and the second collapsible side support 140 is coupled to the second upper member 113 at a second frame attachment point 104.

Preferably, as the upper members slide to the extended useable position, the first frame attachment point and second frame attachment point moves away from each other.

As the collapsible side supports 130, 140 are also coupled to the blade 200 at the blade ends 202, 204, movement of the first and second frame attachment points 102, 104 away from each other will tension the blade.

Preferably, the collapsible side supports 130, 140 are rigid in the extended useable condition so that movement of the first and second frame attachment points is transferred and results in blade tensioning.

### Over-Centre Locking Mechanism

In the most preferred configurations, the tensioning mechanism 400 is an over-centre tensioning mechanism which moves the frame 100 between an unlocked position (FIGS. 6, 13A) and an over-centre locked position (FIGS. 8, 13). In the unlocked position, the hacksaw 1 is not held under tension and therefore it is free to move to its folded condition. In the locked position, the hacksaw 1 is held under tension and locked in the extended useable condition.

It is anticipated in some independent configurations, the tensioning mechanism is not an over-centre tensioning mechanism, and another tensioning mechanism is adopted. In these configurations, the improvement of the folding hacksaw lies with the pivoting handle features as previously described.

In the preferred configurations, the tensioning mechanism is located on the upper member 110 for easy access.

Preferably, the over-centre tensioning mechanism comprises an over-centre link assembly. The link assembly has a first link element 401 and a second link element 403 pivotably coupled together at a first pivot point (FIG. 13A, 14A).

Preferably, the first link element 401 is pivotably coupled to the first upper member 112 at a second pivot point, and the second link element 403 is pivotably coupled to the second upper member 113 at a third pivot point, so that the pivoting motion of the link elements 401 causes the sliding motion of the first and second upper members 112, 113 of the multi-part upper member 110.

Preferably, one or both the first and second upper members 112, 113 slide relative to the other first and second upper members.

In the preferred configurations, the upper members 112, 113 each comprises a longitudinal receiving slot 405 to receive a corresponding second or third pivot point 412, 413. Preferably, the longitudinal receiving slot 405 is located towards the top of the upper member 110. The second and third pivot points 412, 413 travel along the longitudinal receiving slots 405 between the unlocked position (FIG. 13A) and an over-centre locked position (FIG. 13B).

The longitudinal receiving slot 405 provides a ‘centre-line’ (L), which the first and second link elements 401, 403 pivot relative to as shown in the schematics 14A-C.

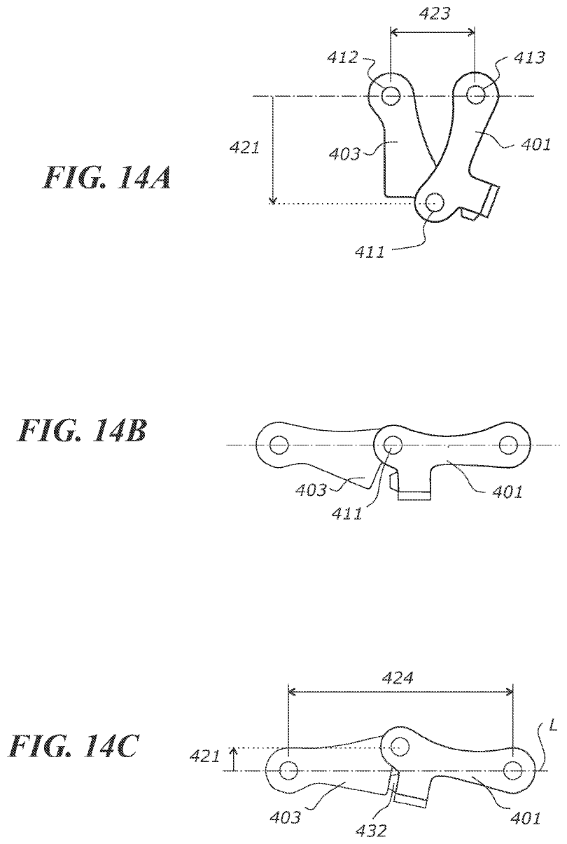

FIGS. 14A-C are schematics which show the motion of the linkage assembly between the folded condition and extended hacksaw conditions.

In the unlocked position (FIGS. 14A, 13A), the first pivot point 411 is forced a first distance 421 from the centre-line (L) in a first direction.

The first pivot point 411 is forced a second distance 422 from the centre-line in a second opposite direction to the over-centre locked position (FIGS. 14C, 13B).

The second distance 422 from the centre-line is preferably less than the first distance 421.

Preferably, the hacksaw 1 comprises a pivot stop 432 to limit the movement of the first pivot 411 and limit the distance travelled by it in the second direction 422. As the first pivot 411 travels further in the second direction 422, gradually more tension is applied to the blade 200, until the first pivot engages the pivot stop.

In the preferred configurations, the pivot stop 432 is located on one of the first or second link elements 401, 403 to stop pivoting as shown in FIGS. 13B and 14C.

As shown in FIG. 14C, in some configurations, the pivot stop 432 is a protrusion on the first link element 401. In other configurations, the pivot stop 432 is a separate element (e.g. a grub screw) attached to the link element.

Preferably, the pivot stop 432 engages a surface of the second link element 402 to limit pivoting in the second direction 422.

The pivot stop prevents the first pivot point 411 from travelling too far past the centre-line (L) in the second direction 422.

In comparison, the first pivot point 411 is free to travel a greater distance in the first direction 421 to draw the second and third pivot points 412, 413 together in the unlocked position.

Preferably, in the locked position the distance 424 between the second and third pivot points 412, 413 is greater than the distance 423 between the second and third pivot points in the unlocked condition, so that the first and second upper members are forced apart and the blade is put under tension.

FIG. 14B shows the first and second link elements 401, 403 at the centre position. The link assembly moves to the over-centre locked position, where the link elements pivot past this centre-position, towards an opposite direction to the unlocked position.

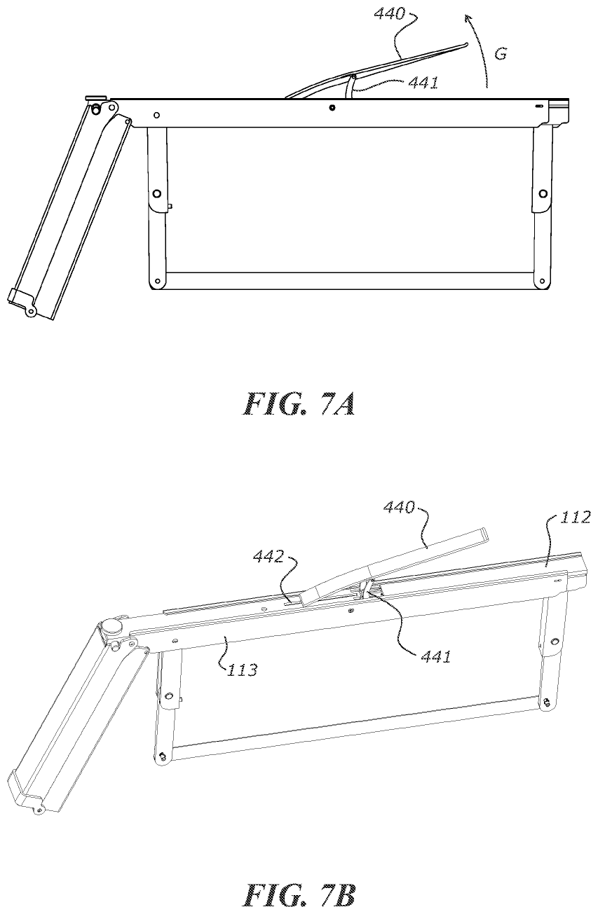

Preferably, the over-centre tensioning mechanism comprises a lever 440 (best shown in FIG. 7B) to force the first pivot point 411 between the unlocked and over-centre locked positions.

The lever 440 comprises a locking direction (G) to lock the frame in the extended useable condition. As the lever 440 travels in the locking direction, tension is applied to the blade 200. Once the first pivot 411 engages the pivot stop 432, the blade is at its highest tension. Further movement of the lever in the locking direction (G) will not increase tension, but the lever may continue travelling until it rests against the frame 100.

Preferably, the lever 440 comprises an unlocking direction in a direction opposite the locking direction.

In one configuration, the locking direction (G) is upwards away from the frame 100.

Optionally, the lever 440 comprises a lever link 441 to couple the lever to the first pivot point 441 as best shown in FIGS. 7A-B.

Optionally, the upper member comprises a longitudinal guide slot 442 configured to constrain and guide an end of the lever 440 as shown in FIG. 7B.

Preferably, the an end of the lever comprises a pin to keep the lever 440 slidably engaged in the longitudinal guide slot 442.

In some configurations, the lever 440 can travel along the longitudinal guide slot 442 from a lifted lever position in 7B to a lowered lever position in 1, while the frame 100 remains in the extended useable position and the lever is not being used. This is advantageous, as it allows the hacksaw 1 to be compact and ensures the lever 440 is out of the way during cutting.

Optionally, the lever comprises a magnetic component to keep the lever in the lowered lever position, until sufficient force is applied to lift the lever, to limit the likelihood of unintentional movement of the lever.

The described over-centre tensioning mechanism provides an effective tensioning mechanism for tensioning the blade 200 and also maintain the extended useable condition.

The over-centre tensioning mechanism is advantageous as unintentional movement of the lever will not unlock the hacksaw. Once the tensioning mechanism is in the over-centre locked position, the linkage assembly does not move until the first pivot point is forced towards the first unlocking direction.

Furthermore, the over-centre tensioning mechanism is intuitive to use, can be tensioned quickly for use, provides strength, stability and consistency.

In other configurations, tensioning and locking mechanism known by a skilled person in the art may be used.

Optionally, the folding hacksaw 1 comprises a pre-tension mechanism in addition to the main tensioning mechanism to accommodate minor blade length variations.

In some configurations, the folding hacksaw 1 comprises a fastener 158 (e.g. grub screw) located on one or more the collapsible side supports 130, 140 as referenced on FIG. 6. As the grub screw is tightened the upper side support portion 151 press against the lower side support portion 152 to tension the blade.

The hacksaw 1 is configured to be compact in its folded condition for easy transport and storage.

Preferably, the hacksaw 1 in its folded condition is not substantially longer than the length of the blade 200. Typically, the standard hacksaw blade length is 250 to 300 mm. However, components of the hacksaw 1 can be sized and configured to receive a greater range of blade lengths.

Preferably, the hacksaw 1 in the folded condition has a length between 1.0 and 1.6 times a length of the blade.

Most preferably, the hacksaw 1 in the folded condition has a length between 1.0 and 1.3 times a length of the blade.

Optionally, the blade 200 is removably coupled to the first and second collapsible side supports. A removable blade 200 is useful as so that worn blades can be replaced with sharp new blades.

In some configurations, the blade 200 is coupled to the first and second collapsible side supports with magnets.

It is anticipated the blade 200 can be coupled to the side supports using small clamps, screws, or any other method known in the art.

Optionally, the handle 300 comprises branding or indicia such as ruler imprints.

Optionally, the handle 300 comprises an ergonomic soft rubber coating.

In the preferred configuration, the frame 100 and handle 300 are metal. For example, the frame 100 and handle 300 may be formed from steel, aluminium or other suitable metals known in the art.

Optionally, the handle 300 is plastic injection moulded.

It is anticipated that the frame 100 and handle 300 may be formed from any other materials or a combination of materials, which have adequate physical characteristics such as strength and durability.

The various configurations of the folding hacksaw 1 can provide a range of advantages in relation to ease of use, structural integrity, safety and ease of transport and storage as described.

The ability to of the folding hacksaw to move between an extended useable condition and a folded condition is useful as the extended hacksaw profile allows for effective cutting performance, while the folded condition allows the hacksaw to be stored and transported safely and easily.

The features of the handle in the preferred configurations allows it to function both as a handle and also as a protective cover for the blade to improve the lifespan of the blade and improve safety during non-use.

The over-centre tensioning mechanism in the preferred configurations is a simple and effective mechanism which effectively tensions the blade and locks the hacksaw in the extended useable condition.

Furthermore, the described folding hacksaw is advantageous as components can remain attached as the hacksaw transforms between the extended and folded conditions (i.e. components do not need to be removed to allow for compact storage).

To those skilled in the art to which the invention relates, many changes in construction and widely differing embodiments and applications of the invention will suggest themselves without departing from the scope of the invention as defined in the appended claims.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

1-5. (canceled)

6. A folding hacksaw movable between an extended useable condition and a folded condition comprising:
a frame having:
a longitudinal upper member comprising a first upper member and a second upper member, one or both of said upper members slidable relative to the other upper member in a single degree of freedom in a longitudinal direction, the first and second upper members are constrained from rotating,
a first collapsible side support depending from a front end of said frame and coupled to the first upper member at a first frame attachment point, and
a second collapsible side support depending from a back end of said frame and coupled to the second upper member at a second frame attachment point,
a blade having a first blade end coupled to the first collapsible side support and a second blade end coupled to the second collapsible side support, and
a handle coupled to the frame having a first handle portion and a second handle portion, and
an over-centre tensioning mechanism located on the upper member to move the frame between an unlocked position and an over-centre locked position, and
wherein the over-centre tensioning mechanism moves the first frame attachment point and second frame attachment point away from each other to tension and lock the blade and
wherein a proximal end of the first handle portion is pivotably coupled to the frame and a distal end of the first handle portion is pivotably coupled to the second handle portion, and
wherein a distal end of the second handle portion pivots towards the proximal end of the first handle portion to the first handle condition to form a free-end handle.

7. (canceled)

8. A folding hacksaw as claimed in claim 0 wherein the handle pivots between a first handle condition to form a free-end handle and a second handle condition where the handle engages the upper member and encapsulates the blade

9. A folding hacksaw as claimed in claim 6 wherein the handle comprises an inner handle channel adapted to encapsulate the blade in the second hacksaw folded condition.

10-11. (canceled)

12. A folding hacksaw as claimed in claim 6 wherein the first handle portion and second handle portions pivot together to conceal the inner channel of the handle in the first handle condition to form a comfortable grip.

13. A folding hacksaw as claimed in claim 9 wherein the inner channel encapsulates the upper member when the hacksaw is in its folded condition to provide a compact hacksaw.

14. A folding hacksaw as claimed in claim 6 wherein the handle further comprises a handle locking mechanism to lock the handle in the first handle condition, wherein the handle locking mechanism is one or a combination of the following features:
a) a locking thumbwheel,
b) a magnetic catch,
c) a recess in the upper member to receive a distal end of the second handle portion.

15-16. (canceled)

17. A folding hacksaw as claimed in any one of claim 6 wherein the over-centre tensioning mechanism comprises an over-centre link assembly having:
a first link element and a second link element pivotably coupled together at a first pivot point,
the first link element is pivotably coupled to the first upper member at a second pivot point, and
the second link element is pivotably coupled to the second upper member at a third pivot point,
wherein the pivoting motion of the first and second link elements causes one or both the first and second upper members to slide relative to the other first and second upper member.

18. A folding hacksaw as claimed in claim 17 wherein the first and second upper members each comprises a longitudinal receiving slot to receive a corresponding second or third pivot point, the longitudinal receiving slot providing a centre-line for the first and second link elements to pivot relative to.

19. A folding hacksaw as claimed in claim 17 wherein the first pivot point is forced a first distance from the centre-line in a first direction to the unlocked position, and the first pivot point is forced to a second distance from the centre-line in a second opposite direction to the over-centre locked position, wherein the second distance is less than the first distance.

20. A folding hacksaw as claimed in claim 19 wherein the hacksaw comprises a pivot stop to limit the movement of the first pivot and limit the distance travelled in the second direction.

21. A folding hacksaw as claimed in claim 20 wherein the pivot stop is located on one of the first or second link elements.

22. A folding hacksaw as claimed in claim 17 wherein the hacksaw comprises a locked distance between the second and third pivot points greater than an unlocked distance between the second and third pivot points so that the first and second upper members are forced part and the blade is under tension in the greater locked distance.

23. A folding hacksaw as claimed in claim 17 further comprising a lever to force the first pivot point between the unlocked and over-centre locked positions.

24. A folding hacksaw as claimed in claim 23 further comprising a lever link to couple the lever to the first pivot point.

25. (canceled) .

26. A folding hacksaw as claimed in claim 6 wherein the upper member comprises an underside channel to receive the blade in the folded condition.

27. A folding hacksaw as claimed in claim 6 wherein the blade retracts upwards towards the upper member from the extended useable condition to the folded condition.

28. A folding hacksaw as claimed in claim 6 wherein each of the first and second collapsible side supports comprises:
an upper side support portion coupled to the upper member and
a lower side support portion coupled to the blade, and
wherein the upper side support portion and the lower side support portion are pivotable coupled to each other at a pivot point.

29. (canceled)

30. A folding hacksaw as claimed in claim 28 further comprising a pivot blocking feature so that the collapsible side supports are not collapsible outwards past the hacksaw extended useable condition.

31. A folding hacksaw as claimed in claim 30 wherein the pivot blocking feature is a movably mounted anti-pivot block having:
a blocking condition wherein the block engages a corresponding side support to prevent it from pivoting and
a non-blocking condition where the block does not engage the side support.

32-36. (canceled)

37. A folding hacksaw as claimed in claim 6 wherein the frame and the blade defines a substantially rectangular frame profile in the extended useable condition and a rectangular bar profile in the folded condition.

38. (canceled)
